(19) United States
(12) Patent Application Publication
(10) Pub. No.: US 2013/0305887 A1
(43) Pub. Date: Nov. 21, 2013

(54) PIVOTING STRUCTURE OF A TOOL

(71) Applicant: Jim Lai, Changhua City (TW)

(72) Inventor: Jim Lai, Changhua City (TW)

(21) Appl. No.: 13/989,801

(22) PCT Filed: Jan. 31, 2011
(86) PCT No.: PCT/CN11/70839

§ 371 Date: May 27, 2013

(51) Int. Cl. B25B 23/00

(52) U.S. Cl. CPC B25B 23/0028
USPC 81/177.8

(57) ABSTRACT

A pivoting structure of a tool includes a handle, a head member and pivoting set. The head member is engaged with the handle via the pivoting set. Under this arrangement, when the pivoting set is axially moved, the head member is disengaged from the handle and is rotatable relative to the handle.

### BACKGROUND OF THE INVENTION

1. Field of the Invention

The present invention relates to a pivoting structure, and more particularly to a pivoting structure of a tool.

2. Description of Related Art

A conventional pivoting structure of a tool comprises a handle and a head member which is pivoted on the handle. One end of the head member has a ratchet portion. One end of the handle has a plurality of teeth. The ratchet portion is engaged with the teeth. The ratchet portion is disengagable from the teeth step by step. Under this arrangement, an angle between the handle and the head member is adjustable. Therefore, when a wrenching space is narrow, a user can smoothly operate the conventional pivoting structure of a tool because the angle between the head member and the handle is adjustable.

However, the ratchet portion and the teeth are both exposed from the conventional pivoting structure of a tool, so that the conventional pivoting structure of a tool isn't good-looking. In addition, the engagement between the ratchet portion and the teeth is not stable.

The present invention has arisen to mitigate and/or obviate the disadvantages of the conventional.

### SUMMARY OF THE INVENTION

The main objective of the present invention is to provide a pivoting structure.

To achieve the objective, a pivoting structure of a tool comprises a handle having a first pivoting member and a second pivoting member both defined at one end thereof, the two pivoting members opposite to each other, the first pivoting member having a first lateral hole opened therethrough, the second pivoting member having a second lateral hole opened therethrough, the first lateral hole having a plurality of first annular teeth defined at an internal end thereof, the second lateral hole having a plurality of second annular teeth defined at an internal end thereof, a head member having a pivoting portion defined at one end thereof, the pivoting portion corresponding to a pivoting gap between the two pivoting members, the pivoting portion having a central gear hole opened thereon, the central gear hole corresponding to the two lateral holes, a pivoting set passing through the two lateral holes and the central gear hole, the pivoting set having a pivoting rod, a central gear and a lateral gear, the central gear and the lateral gear both mounted around the pivoting rod, the central gear and the lateral gear spaced from each other, the central gear engaged with the central gear hole and the first annular teeth, and the lateral gear engaged with the central gear hole and the second annular teeth. Wherein, the pivoting set has an abutting plate, a button and a spring; the abutting plate is locked at one end of the pivoting rod and is located outside of the second pivoting member; the button is defined at another end of the pivoting rod and is located outside of the first pivoting member; the spring is mounted around the pivoting rod; two ends of the spring are respectively abutted against the button and the first lateral hole.

Under this arrangement, when the pivoting rod is axially moved, the central gear and the lateral gear are both axially moved by the motion of the pivoting rod; thereafter, the central gear is moved into the central gear hole and is only engaged with the central gear hole; the lateral gear is disengaged from the central gear hole and the second annular teeth; as a result, the head member is unlocked and is rotatable relative to the handle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 4 is a side view of the present invention;

FIG. 5 is another cross-sectional view of the present invention; and

FIG. 6 is a schematic view of the present invention for showing a head member rotating relative to a handle.

### DETAILED DESCRIPTION OF THE INVENTION

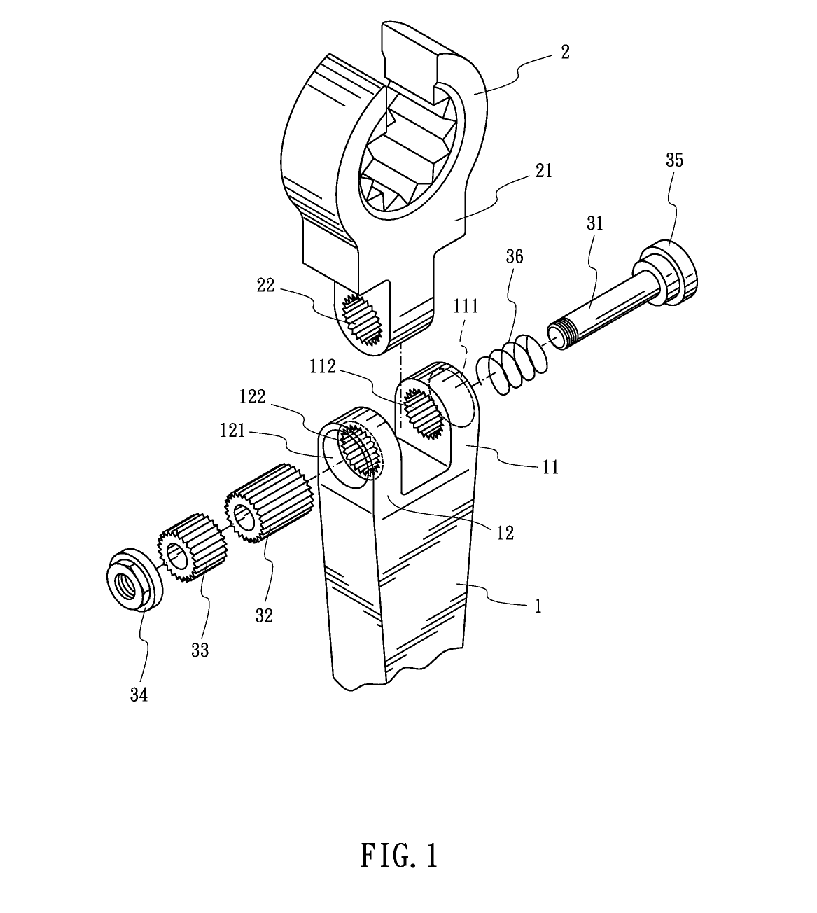

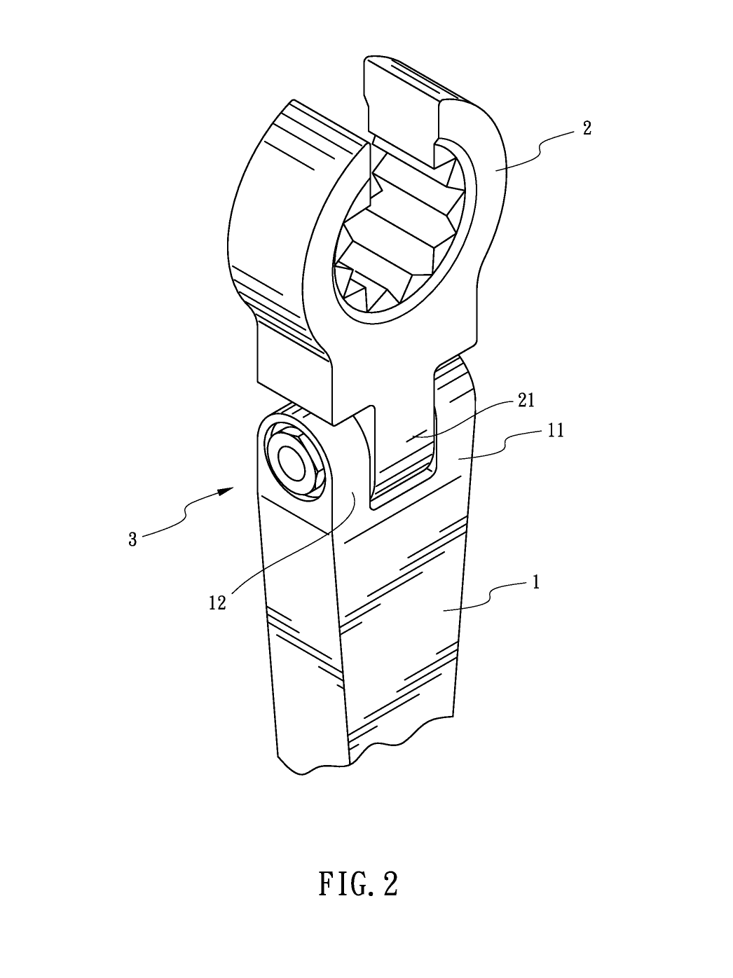

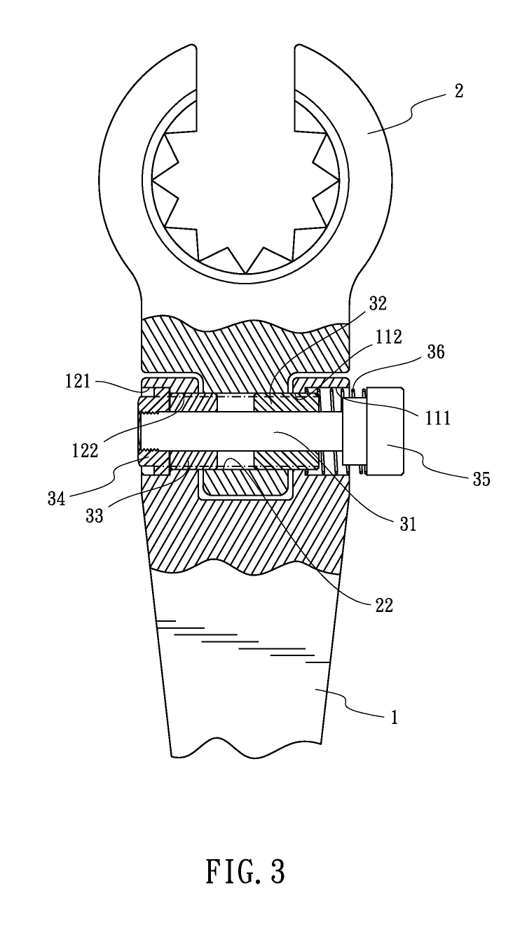

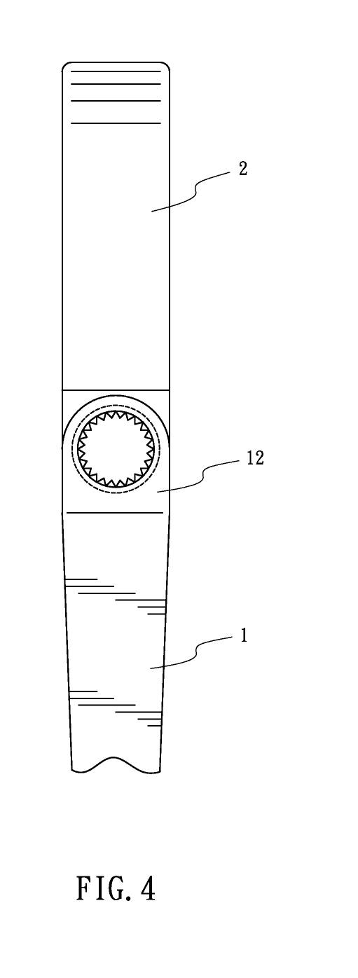

Referring to FIGS. 1-4, a pivoting structure of a tool in accordance with the present invention comprises a handle 1, a head member 2 and a pivoting set 3. The handle 1 has a first pivoting member 11 and a second pivoting member 12 both defined at one end thereof. The two pivoting members 11, 12 are opposite to each other. A pivoting gap is defined between the two pivoting members 11, 12. The first pivoting member 11 has a first lateral hole 111 opened therethrough. The second pivoting member 12 has a second lateral hole 121 opened therethrough. The first lateral hole 111 has a plurality of first annular teeth 112 defined at an internal end thereof. The second lateral hole 121 has a plurality of second annular teeth 122 defined at an internal end thereof. The handle 1 has another end which is defined as a handlebar for a user to handle.

The head member 2 has a pivoting portion 21 defined at one end thereof. The pivoting portion 21 corresponds to the pivoting gap between the two pivoting members 11, 12. The pivoting portion 21 has a central gear hole 22 opened at a center thereof. The central gear hole 22 corresponds to the two lateral holes 111, 121. The head member 2 has another end which is defined as an operating end (the operating end is an open end, an adjustable end, a box end or a ratchet end).

The pivoting set 3 passes through the two lateral holes 111, 121 and the central gear hole 22, so that the head member 2 is pivotally connected to the handle 1 via the pivoting set 3. The pivoting set 3 is axially movable relative to the two lateral holes 111, 121 and the central gear hole 22. The pivoting set 3 has a pivoting rod 31, a central gear 32, a lateral gear 33, an abutting plate 34, a button 35 and a spring 36. The central gear 32 and the lateral gear 33 are both mounted around the pivoting rod 31. The central gear 32 and the lateral gear 33 are spaced from each other. The central gear 32 is engaged with the central gear hole 22 and the first annular teeth 112. The lateral gear 33 is engaged with the central gear hole 22 and the second annular teeth 122. The abutting plate 34 is screwed at one end of the pivoting rod 31 and is located outside of the second pivoting member 12. The button 35 is defined at another end of the pivoting rod 31 and is located outside of the first pivoting member 11. The spring 36 is mounted around the pivoting rod 31. Two ends of the spring 36 are respectively abutted against the button 35 and the first lateral hole 111.

Referring to FIGS. 1-4, the spring 36 pushes the button 35 at another end of the pivoting rod 31 via a recovery force thereof, so that the central gear 32 is engaged with the central gear hole 22 and the first annular teeth 112 and the lateral gear 33 is engaged with the central gear hole 22 and the second annular teeth 122. Therefore, the head member 2 is nonrotatable relative to the handle 1; in other words, the head member 2 is locked.

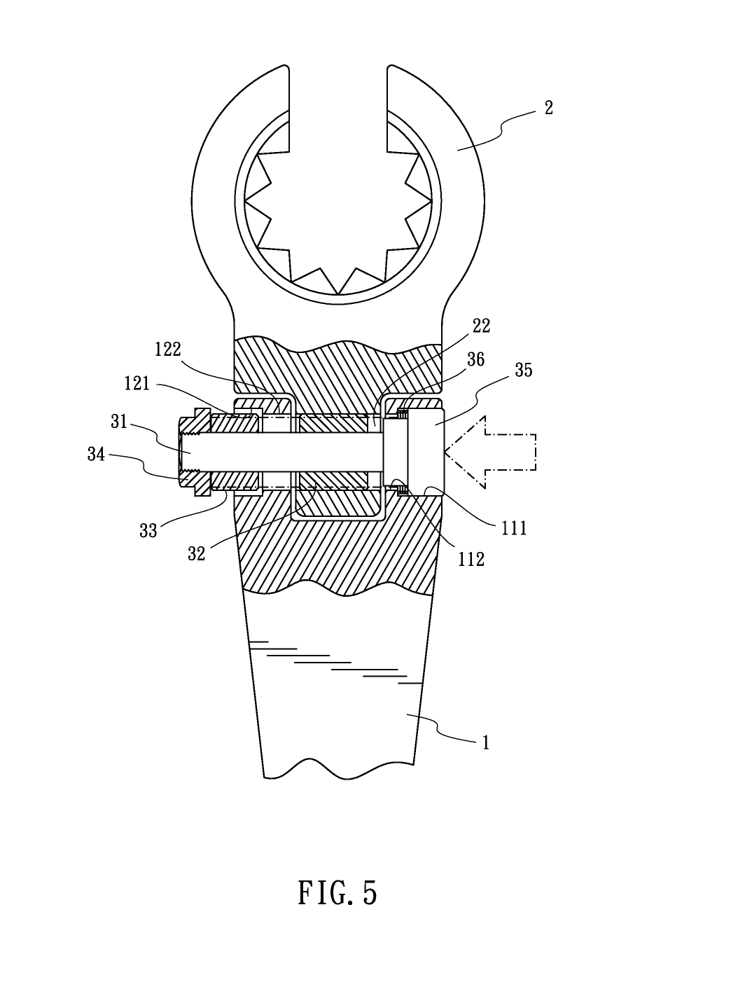

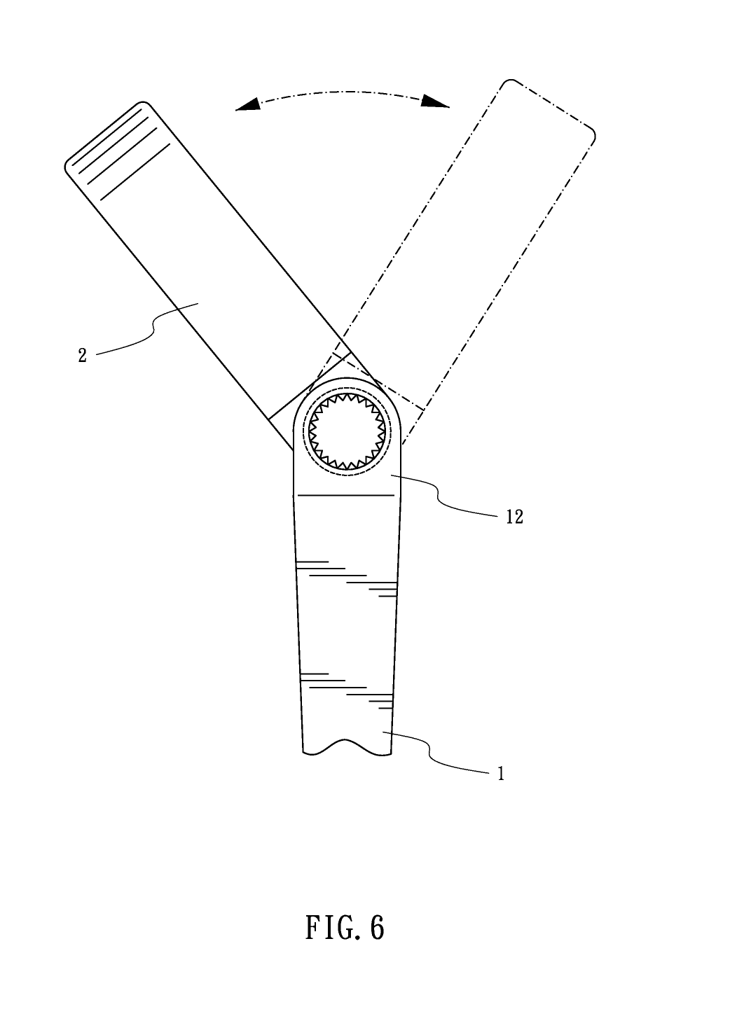

Referring to FIGS. 5-6, when a user wants to unlock the head member 2 and adjust an angle between the head member 2 and the handle 1, the user presses the button 35 at another end of the pivoting rod 31 so as to axially move the pivoting rod 31; then, the central gear 32 and the lateral gear 33 are both axially moved by the motion of the pivoting rod 31; simultaneously, the spring 36 is compressed by said motion; thereafter, the central gear 32 is moved into the central gear hole 22 and is only engaged with the central gear hole 22; the lateral gear 33 is moved away from the central gear hole 22 and is disengaged from the central gear hole 22 and the second annular teeth 122; as a result, the head member 2 is unlocked and is rotatable relative to the handle 1. After the user adjusts the angle between the head member 2 and the handle 1, the user releases the button 35; then, the spring 36 pushes the pivoting rod 31 back via the recovery force thereof; thereafter, the central gear 32 and the lateral gear 33 is moved back by the motion of the pivoting rod 31; as a result, the central gear 32 is engaged with the central gear hole 22 and the first annular teeth 112 again and the lateral gear 33 is engaged with the central gear hole 22 and the second annular teeth 122 again. Therefore, when a wrenching space is narrow, the user can smoothly operate the present invention because the angle between the head member 2 and the handle 1 is adjustable; in addition, the pivoting structure is assembled between the head member 2 and the handle 1 and isn't exposed from the present invention, so that the present invention is good-looking.

Furthermore, a structure of the present invention is simple; all the parts of the present invention could be made via modeling method and are easy to manufacture; the present invention is easy to assemble because boring process is not necessary; the engagement between the central gear 32, the lateral gear 33, the central gear hole 22 and the annular teeth 112, 122 is firm; the user can press or release the button 35 by only one hand.

Although the invention has been explained in relation to its preferred embodiment, it is to be understood that many other possible modifications and variations can be made without departing from the spirit and scope of the invention as hereinafter claimed.

What is claimed is:

1. An adjustable wrench comprising:
a handle having a first pivoting member and a second pivoting member both defined at one end thereof, the two pivoting members opposite to each other, the first pivoting member having a first lateral hole opened therethrough, the second pivoting member having a second lateral hole opened therethrough, the first lateral hole having a plurality of first annular teeth defined at an internal end thereof, the second lateral hole having a plurality of second annular teeth defined at an internal end thereof;
a head member having a pivoting portion defined at one end thereof, the pivoting portion corresponding to a pivoting gap between the two pivoting members, the pivoting portion having a central gear hole opened thereon, the central gear hole corresponding to the two lateral holes; and
a pivoting set passing through the two lateral holes and the central gear hole, the pivoting set having a pivoting rod, a central gear and a lateral gear, the central gear and the lateral gear both mounted around the pivoting rod, the central gear and the lateral gear spaced from each other, the central gear engaged with the central gear hole and the first annular teeth, the lateral gear engaged with the central gear hole and the second annular teeth, the pivoting set having an abutting plate, a button and a spring, the abutting plate secured at one end of the pivoting rod and located outside of the second pivoting member, the button defined at another end of the pivoting rod and located outside of the first pivoting member, the spring mounted around the pivoting rod, two ends of the spring respectively abutted against the button and the first lateral hole.
